(19) United States
(12) Patent Application Publication
(10) Pub. No.: US 2008/0144175 A1
(43) Pub. Date: Jun. 19, 2008

(54) Display Device For Producing Quasi-Three-Dimensional Images

(75) Inventor: Peter Allan Simonsen, Copenhagen O (DK)

Correspondence Address: FOLEY AND LARDNER LLP;SUITE 500, 3000 K STREET NW, WASHINGTON, DC, 20007, US

(73) Assignee: Vizoo Invest ApS

(21) Appl. No.: 11/814,703

(22) PCT Filed: Jan. 26, 2006
(86) PCT No.: PCT/DK06/00041

§ 371 Date: Sep. 17, 2007

Related U.S. Application Data
(60) Provisional application No. 60/674,502, filed on Apr. 25, 2005.

(30) Foreign Application Priority Data
Jan. 26, 2005 (DK) PA 2005 00127
Apr. 25, 2005 (DK) PA 2005 00600

(51) Int. Cl. G02B 27/24

(52) U.S. Cl. 359/479

(57) ABSTRACT

The present invention provides a display device that enhances spatial aspects of three-dimensional objects recorded and displayed on two-dimensional surfaces. A display device according to the invention comprises a pyramid-like part and display means (801). The pyramid-like part has semi-transparent, partly reflective facets (1501-1504). The display means provides images to be reflected on the facets (1501-1504) of the pyramid-like part. Methods are provided for recording and displaying picture angle recordings on a display device according to the invention.

### FIELD OF THE INVENTION

This invention provides a display device for use for instance for display purposes, design purposes or as a display part of a surveillance system.

### BACKGROUND OF THE INVENTION

Within many disparate scenarios there is a need for displaying objects on a two-dimensional (2D) surface in such a manner that the object to be displayed appears as physical as possible. An LCD display is an example of such a 2D surface. A mechanism that is very useful in giving off this impression lies in recording images of the object while rotating it and then displaying the recorded images on the LCD display. In this display mode, a viewer's brain will tend to perceive a spatial aspect of the object.

U.S. Pat. No. 6,356,397 discloses a pyramid formed by triangular mirrors for use in a panoramic viewing system. Here cameras monitor each mirror so that a panoramic view is obtained. It is mentioned that an image processing device such as a projector can be used instead of the cameras.

### SUMMARY OF THE INVENTION

It is an object of the present invention to provide a display device that can enhance the display of three-dimensional objects on one or more two-dimensional surfaces. It is also an object of the invention to provide a display device that provides the possibility of displaying a location from several angles in a way that is intuitive for a viewer.

In the present context, the term fundamental pyramoid will be used to refer to a solid, semi-transparent pyramid-like shape, comprising a number of triangular facets, called mirror facets, and a base, called a pyramoid base. In the present context, a mirror facet is a facet of the fundamental pyramoid that has mirror properties, that is, a facet that is able to reflect light introducing little or no diffusion.

In the present context, the term semi-transparent is used in the common sense of the term. An operative definition is that a semi-transparent material is a material that is at least partly transparent to white light.

A fundamental pyramoid may consist of any material or composition of materials, as long as it is semi-transparent and its facets are partly reflective.

In the present context, a display pyramoid is a structure that is derived from a fundamental pyramoid and that is either
the fundamental pyramoid as such, or
a modification of the fundamental pyramoid by introduction of one or more cavities.

It should be understood that this definition does not imply that a display pyramoid is fabricated by any particular method, for instance by modifying a fundamental pyramoid as such. The concept of a fundamental pyramoid is used here as an aid in defining what a display pyramoid may look like. In an example of one practical embodiment, the display pyramoid is fabricated by joining a number of semi-transparent plane mirror sections to form a pyramid shape. The mirror sections could for instance be joined by any kind of assembling means such as sleeves made of an elastomer or be cemented or glued together. This type of construction is illustrated schematically in FIG. 5B.

A display pyramoid's base plane is a plane that is parallel to the pyramoid base of the fundamental pyramoid from which the display pyramoid is derived.

In a first aspect, the present invention provides a display device comprising
an at least partly semi-transparent display pyramoid derived from a fundamental pyramoid, said display pyramoid comprising a pyramoid base plane and at least three display pyramoid mirror facets (said number is denoted n),
display means comprising one or more image display surfaces, each image display surface being positioned in such a way that light to be emitted from said one or more image display surfaces can reach directly at least a part of one or more of the display pyramoid mirror facets.

This aspect defines a class of display devices that comprise an at least partly semi-transparent display pyramoid with reflecting facets as well as one or more image display surfaces that can shine light directly onto one or more of the pyramoid mirror facets. The semi-transparency of the display pyramoid allows a viewer to look inside the display pyramoid and at the same time see reflections of at least a part of an image displayed on at least one display surface.

It is a disadvantage of the panoramic viewing system disclosed by U.S. Pat. No. 6,356,397 that the mirrors are not semi-transparent. Thereby, the projection of an image onto the mirrors will not create the effect described in the above. Also, U.S. Pat. No. 6,356,397 discloses a projector for projecting an image onto the mirrors. Such projection does not form an image visible to the viewer and does therefore not create the effect intended by the present invention. A projector generates rays of light which will form an image only when illuminating an image forming surface such as a screen.

The display pyramoid and the display means may be connected directly by mechanical means, or the display pyramoid and the display means may be positioned in an arrangement by separate means.

The display means comprises at least one display screen or image-forming surface for displaying the intended picture information. On a display screen or image-forming surface, a viewer can watch a picture as such. This is in contrast to a projector, which may emit the intended picture information, but also requires an image-forming surface to make the picture information directly accessible to a viewer.

In order for images on at least one of the one or more the display surfaces in a display device to be reflected to a reasonable degree in the display pyramoid's mirror facets or parts thereof, the one or more display surfaces must be within a reasonable distance from the display pyramoid, although any distance will work, in principle. Reasonably, a longest distance from any point on any of the one or more display surfaces to any point on the display pyramoid is equal to or less than three times a longest edge of the fundamental pyramoid from which the display pyramoid is derived. In certain useful embodiments of the invention, said longest distance is more than twice said longest edge. A smallest acceptable value of a longest distance is 3/2 times a longest edge, but for many practical applications this longest distance is too short.

The condition above limits the size of the totality of the one or more display surfaces. It also sets a distance from the display pyramoid within which the one or more display surfaces may be located in order for the combined display pyramoid and one or more display surfaces to reasonably form a single unit or arrangement.

Each display surface may be planar or non-planar. As mentioned in the first aspect of the invention, any point on a display surface that forms part of an embodiment of the invention must be able to shine light directly onto at least a part of at least one of the pyramoid mirror facets of said embodiment. LCD displays, computer monitors, and television sets have substantially planar display surfaces. Cloth can also be used to form a planar display surface. Planar display surfaces can easily reproduce, in a natural fashion, images that are recorded by conventional camera means, such as digital cameras and film cameras, and thus planar display surfaces are desirable.

It may be useful to form a composite display surface by combining several smaller display surfaces. This could be in the form of an array of LCD displays, such as a packed 2-by-2 array, which can be a practical substitute for a single, large LCD display. Smaller displays are easier to handle, and if one display in such a configuration fails, it can be relatively easily replaced.

In a preferred embodiment, the display means has a single, planar display surface, as provided for instance by an LCD display. The display screen may have any shape, for instance a rectangular 4:3 format, 16:9 format, 1:1 format, or an oval shape of some sort.

The position of the one or more display surfaces in a display device may result in two or more reflections combining when the display device is observed from certain points of view. By introducing light shades on the edges of a display pyramoid, such reflections can be minimized or even eliminated. A single light shade can minimize the problem for a set of two adjacent mirror facets. Using a number of light shades equal to the number of mirror facets, reflections between all pairs of adjacent mirror facets can be minimized or eliminated.

Light shades may be placed on the pyramoid edges, one light shade at each edge, said light shades being placed and shaped in such a way that the totality of the one or more display surfaces is divided into n image sections, each of which can transmit light to only one pyramoid mirror facet.

In more general terms, one or more light shades may be placed at one or more of a display pyramoid's edges, each light shade being shaped and positioned in such a way that there exists a part of the totality of the one or more display surfaces characterized in that light to be emitted from said part can reach at most n−1 of the display pyramoid's mirror facets.

An embodiment of the invention that lacks symmetry may have a viewer become preoccupied with the display device as such instead of with images displayed on the display device. For this reason, it is preferred that the one or more display surfaces are substantially parallel to the display pyramoid base plane. For the same reason, it is also preferred that the mirror facets all form the same angle with respect to the pyramoid base plane. In many applications, an angle of 45 degrees will be preferable. In some applications an angle between 20 and 70 degrees, such as between 30 and 60 degrees, such as between 40 and 50 degrees, may be preferable.

A display pyramoid may contain one or more cavities. In preferred embodiments, the display pyramoid is mostly hollow, with thin walls.

A display pyramoid's mirror facets may contain gouges. A mirror facet is characterized in part by its coverage ratio. A mirror facet's coverage ratio is the area of said mirror facet divided by the area of the corresponding mirror facet in the fundamental pyramoid from which the display pyramoid is derived. If a display pyramoid is derived by gouging one hole in a mirror facet of a fundamental pyramoid and that hole has a total area of 40% of the area of the corresponding mirror facet in the fundamental pyramoid, the coverage ratio for the resulting mirror facet in the display pyramoid is 0.6 because 60% of the surface of the mirror facet in the fundamental pyramoid remains in the display pyramoid.

In preferred embodiments, each display pyramoid facet has a coverage ratio of at least 1/6, such as at least 1/5, such as at least 1/4, such as at least 1/3, such as at least 1/2, such as at least 3/4, such as at least 4/5, such as at least 9/10, such as equal to 1.

A coverage ratio less than 1 may provide several benefits. A viewer may see the inside of a display pyramoid by virtue of the semi-transparency property. In a display device wherein one or more mirror facets have a coverage ratio less than 1, the visibility of an inner part of the display pyramoid and/or of objects or beings therein, may be increased. In case sound is generated inside the pyramoid to be heard outside the pyramoid, one or more holes, such as a grid of holes, can help sound escape from the inside.

If one or more gouges in a display pyramoid connect to a cavity inside the display pyramoid, the display means can be used to illuminate at least a part of the inside of the display pyramoid and objects or beings therein. In this way, lighting can be provided inside the pyramoid and be controlled via the display means. Elaborate lighting schemes for illuminating the inside of the pyramoid can be employed.

Reducing a mirror facet's coverage ratio in a display pyramoid can create very useful effects, but at a coverage ratio less than 0.25, corresponding for instance to the area of a triangle shaped like the mirror facet but with dimensions scaled down by a factor of 2, the display device as such will tend to distract a viewer.

Lighting means inside a partly hollow pyramoid is useful in case there are objects inside the display pyramoid that are not well lit. Because the display pyramoid mirror facets are only semi-transparent, they absorb part of whatever light is being emitted from the inside of the pyramoid. Providing lighting can improve the visibility of an object or objects located inside the display pyramoid.

If objects or beings inside a display pyramoid provide sound to be accessible outside the display pyramoid, it may be desirable to incorporate microphone means inside the display pyramoid, or at least positioned to substantially capture the sound. Microphone means could supplement holes in one or more facets, or could be used exclusively as means for making sound from inside the display pyramoid accessible at the outside.

It might also be useful to incorporate speaker means for reproducing sound. Such speaker means could for instance be attached or incorporated into at least one of the one or more display surfaces, or it might be attached to the display pyramoid. Alternatively, the speaker means may be provided by other means, not as part of an embodiment of the invention as such.

In another aspect of the invention, a method is provided for reproducing still pictures or moving pictures from a location, the method comprising the steps of
making picture angle recordings of the location from one or more angles,
displaying at least one of the picture angle recordings using a display device according to the invention.

In yet another aspect of the invention, a method is provided for reproducing sound and still or moving pictures from a location, the method comprising the steps of
making picture angle recordings and sound angle recordings at the location from one or more angles, and
displaying at least one of the picture angle recordings on the one or more display surfaces of a display device according to the invention and reproducing sound via speaker means, either via the display device if said display device comprises speaker means, or by speaker means provided not as part of the display device.

Picture angle recordings are reproduced via the one or more display surfaces together with the display pyramoid. Sound angle recordings are reproduced via the speaker means.

In another aspect of the invention, a method is provided that comprises the steps referred to above, and furthermore comprises the step of reproducing, via the speaker means, sound recorded by microphone means inside the display pyramoid. The speaker means may be incorporated into the display device or may be provided for separately.

A display device may further comprise an image processor connected to the display means for the purpose of generating images to be displayed on at least one of the one or more display surfaces.

### BRIEF DESCRIPTION OF THE FIGURES

The invention will now be further described with reference to the figures, wherein

FIG. 1 illustrates a fundamental pyramoid with four mirror facets, wherein all pyramoid mirror facets are equal and each mirror facet forms an angle with respect to the pyramoid base of 45 degrees,

FIG. 2 illustrates a fundamental pyramoid with three mirror facets, wherein all pyramoid mirror facets are equal and each mirror facet forms an angle with respect to the pyramoid base of 45 degrees,

FIG. 3 illustrates a fundamental pyramoid with four mirror facets, wherein at least two mirror facets are unequal,

FIG. 4 illustrates a fundamental pyramoid with three mirror facets, wherein at least two mirror facets are unequal,

FIG. 5A illustrates a display pyramoid that is mostly hollow, with thin walls,

FIG. 5B shows an exploded view of the display pyramoid in FIG. 5A,

FIG. 6 illustrates a display pyramoid as in FIG. 5A wherein three mirror facets contain gouges that connect to an internal cavity,

FIG. 7 illustrates a display pyramoid as in FIG. 5A wherein a top part of all mirror facets is absent,

FIG. 8 illustrates a display device according to the invention that comprises a display pyramoid similar to that in FIG. 5A, and display means consisting of a single display surface,

FIG. 9 illustrates a display device according to the invention that comprises a display pyramoid similar to that in FIG. 5A, and display means comprising four individual display surfaces.

FIG. 10 illustrates a display device similar to that in FIG. 8, further comprising four light shades,

FIG. 11 illustrates an embodiment of the invention similar to that in FIG. 8, wherein the display means is an image-forming surface, which is backlit by a projector,

FIG. 12 illustrates a layout of four same images on the display surface of a display device similar to that in FIG. 10,

FIG. 13 illustrates a display device as in FIG. 10, wherein the images on the display surface are composed as in FIG. 12,

FIG. 14 illustrates a layout of four different images on the display surface of a display device similar to that in FIG. 10,

FIG. 15 illustrates a display device as in FIG. 10, wherein the images on the display surface are composed as in FIG. 14,

FIG. 16 illustrates a large display device comprising an image-forming display surface; speaker means; mirror facets; microphone means; lighting means; and a person inside the display pyramoid. The image-forming display surface is backlit by a projector,

FIG. 17 illustrates a location and four image and sound recorders,

FIG. 18 illustrates the image angle recordings recorded at the location in FIG. 17 by the four image recorders,

FIG. 19 illustrates a layout on the display surface of a display device similar to that in FIG. 10 of the image angle recordings in FIG. 18,

FIG. 20 illustrates a display device similar to that in FIG. 10, wherein the images on the display surface are composed as in FIG. 19.

FIG. 21 illustrates a specific, practical design of a presentation stand based on a display device according to the invention.

### DETAILED DESCRIPTION OF THE FIGURES

The present invention provides a display device that allows a viewer to process visual information more efficiently than is possible when viewing a single two-dimensional display surface directly. This is particularly important when the spatial aspect of a scene or event or object is an important part of the information to be provided to the viewer.

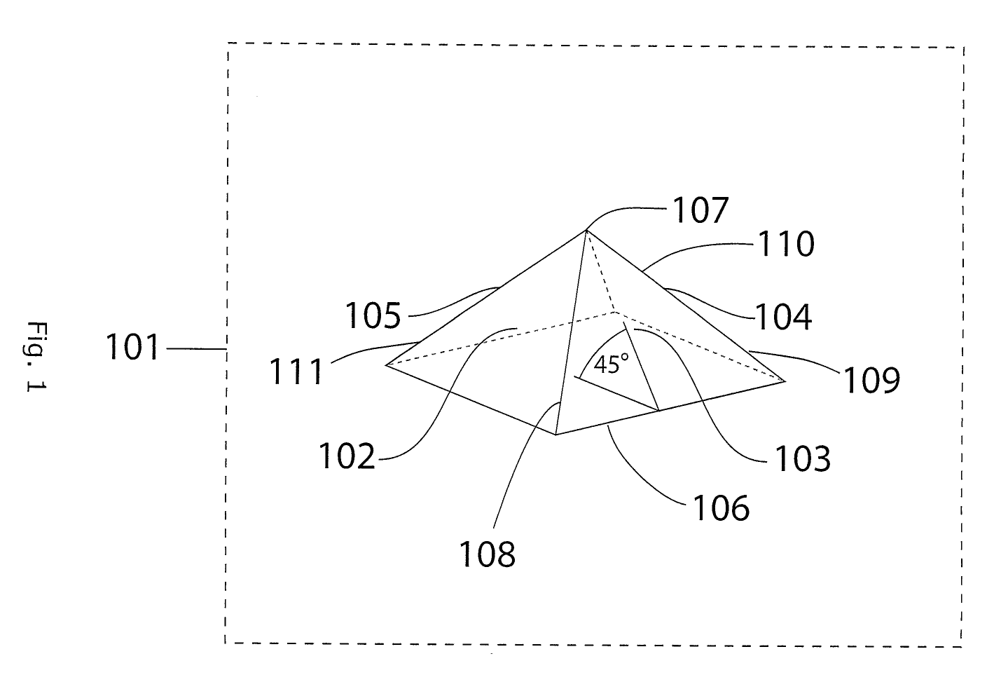

FIG. 1 illustrates schematically a fundamental pyramoid 101 with four facets. The fundamental pyramoid comprises pyramoid mirror facets 102-105, a pyramoid base 106, pyramoid apex 107, and pyramoid edges 108-111. A fundamental pyramoid with n facets comprises n pyramoid mirror facets, n pyramoid edges, and a pyramoid base that has n sides. A fundamental pyramoid is solid and may consist of any material or composition of materials. The pyramoid mirror facets in FIG. 1 all have the same size, and each mirror facet forms an angle with respect to the pyramoid base of 45 degrees.

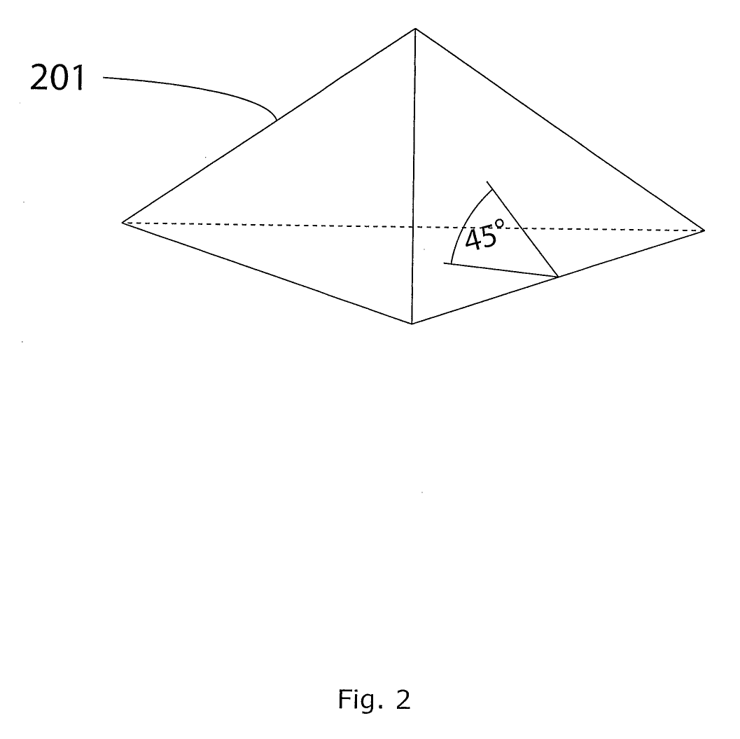

FIG. 2 illustrates a fundamental pyramoid 201 with three mirror facets, wherein all pyramoid mirror facets are equal and each mirror facet forms an angle with respect to the pyramoid base of 45 degrees. A display pyramoid with three, equal mirror facets may be useful as part of a display device according to the invention.

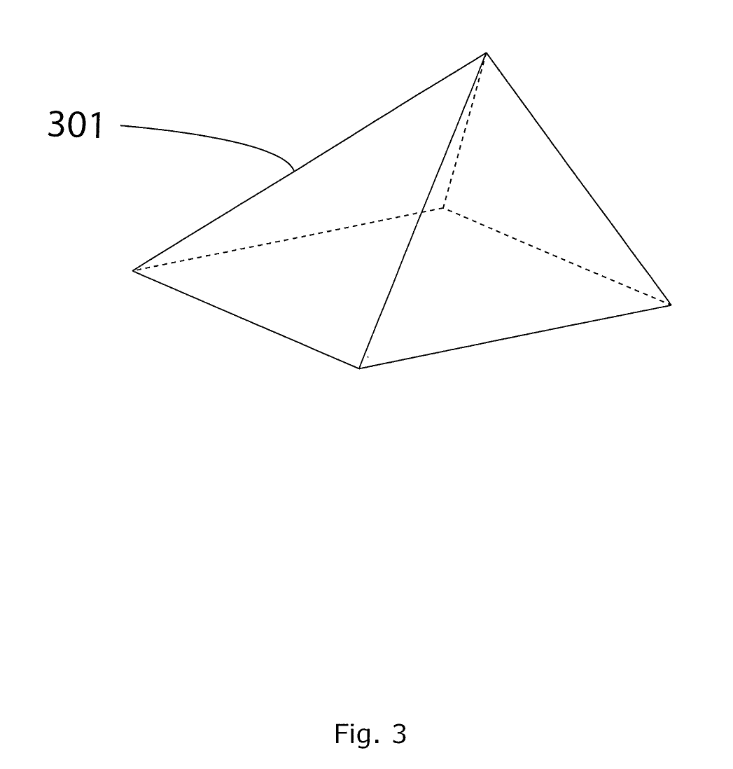

FIG. 3 illustrates a fundamental pyramoid 301 with four mirror facets, wherein at least two mirror facets are not equal. As a display pyramoid part of a display device according to the invention, it may distract a viewer that it lacks symmetry. Also, the angles formed by the facets with respect to the pyramoid base are not all equal. Thus, one or more of the mirror facets in 301 will redirect light in a direction not parallel to the pyramoid base plane. Thus, a spatial aspect of a displayed object may be confused.

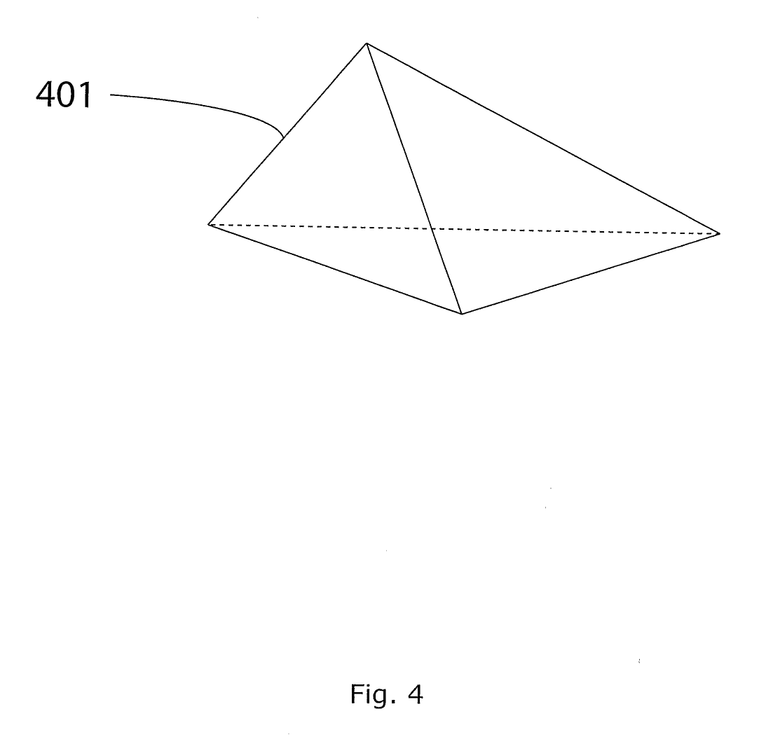

FIG. 4 illustrates a fundamental pyramoid 401 with three mirror facets, wherein at least two mirror facets are not equal. As a display pyramoid part of a display device according to the invention, it may distract a viewer that it lacks symmetry. Also, the angles formed by the facets with respect to the pyramoid base are not all equal. Thus, one or more of the mirror facets in 401 will redirect light in a direction not parallel to the pyramoid base plane. Thus, a spatial aspect of a displayed object may be confused.

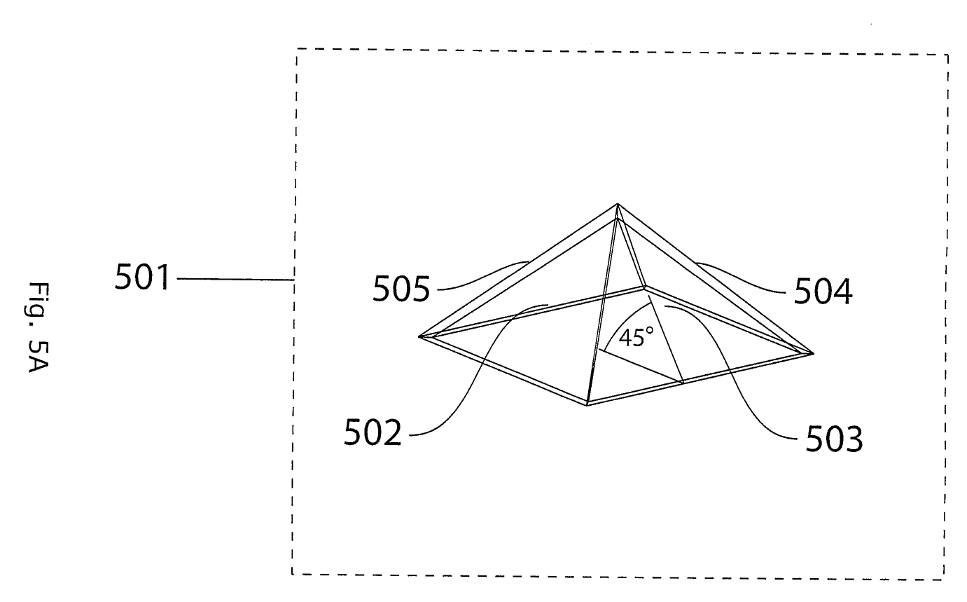

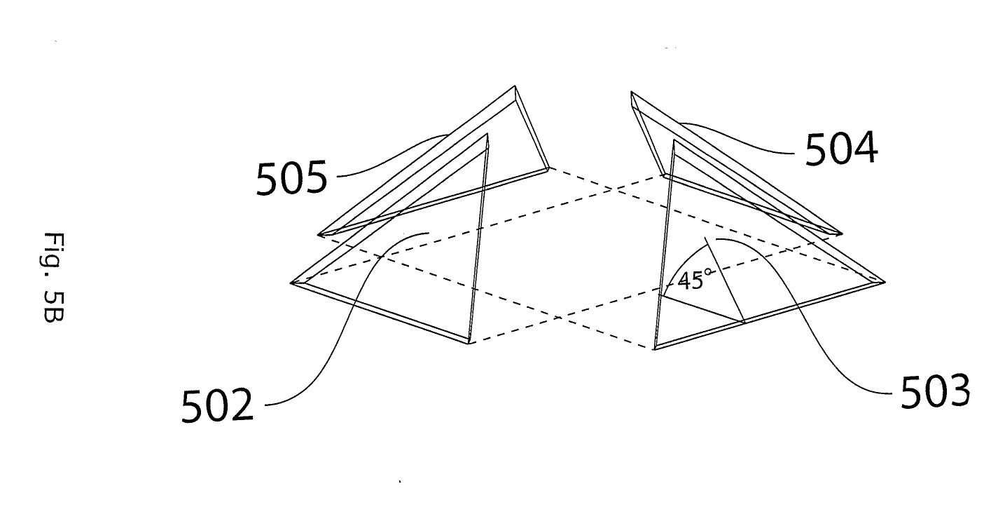

FIG. 5A illustrates a display pyramoid 501 that is mostly hollow, with thin walls. All mirror facets 502-505 form an angle with respect to the display pyramoid base plane of 45 degrees.

FIG. 5B shows an exploded view of the display pyramoid in FIG. 5A.

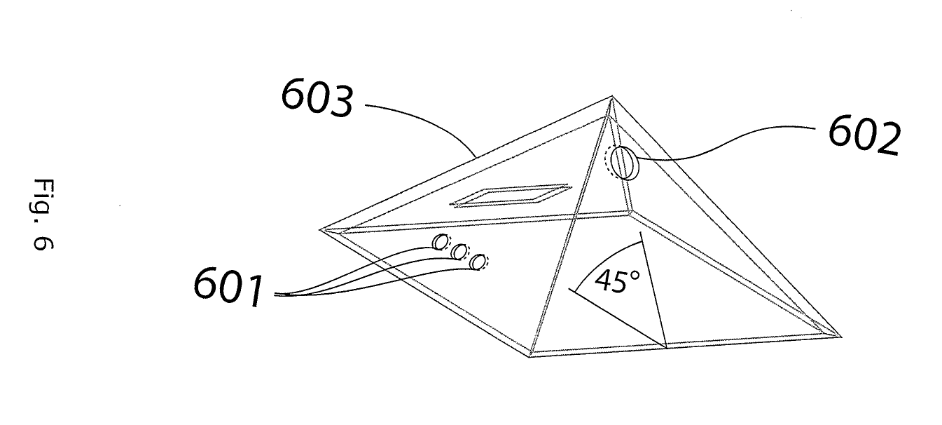

FIG. 6 illustrates a display pyramoid as in FIG. 5A, wherein three mirror facets contain gouges 601-603 that connect to an internal cavity. Such gouges may increase the visibility of objects that might be present inside the display pyramoid and may aid, if applicable, sound inside the pyramoid in getting out. The gouges 601-603 are examples only and do not express a preference or a particular limitation as to how gouges may be shaped or otherwise characterized and provided.

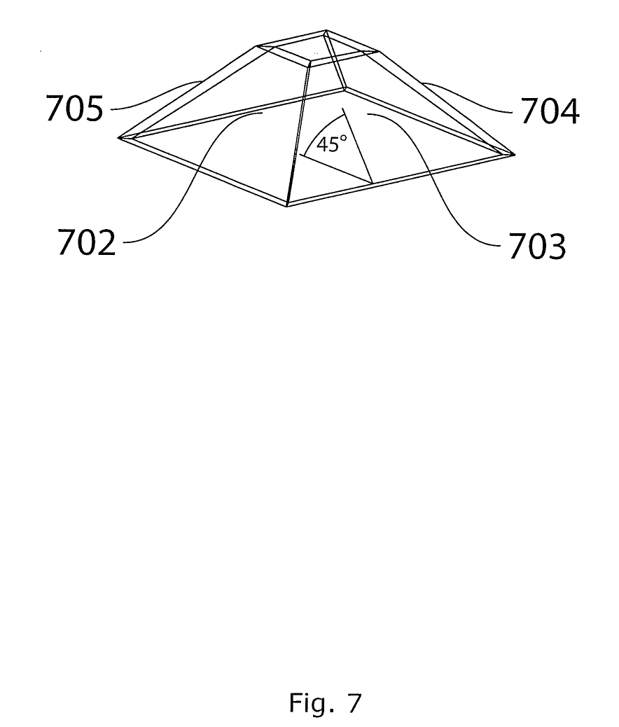

FIG. 7 illustrates a display pyramoid as in FIG. 5A wherein a top part of all mirror facets 702-705 is absent so that a top plane is formed. In practical terms, this is a useful modification because such a top plane can be used to balance an LCD display or other stiff display surface on the display pyramoid to form a display device.

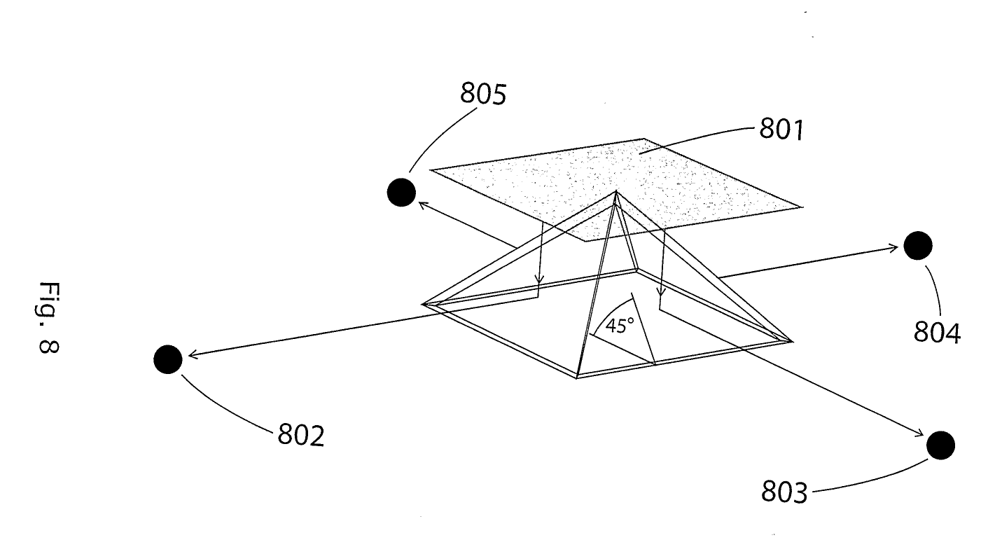

FIG. 8 illustrates a display device according to the invention, comprising a display pyramoid similar to that in FIG. 5A and display means consisting of a single display surface 801, which could be an LCD display. The lines and arrows illustrate that light is emitted from the display surface and reflected by the mirror facets. A viewer at one of the positions 802-805 will be able to view a mirror facet head-on and see the image or images displayed on a part of the display surface located above that mirror facet. The viewing angle is not limited to the lines in the Figure, but is instead quite wide, which one may realize by tracing various possible paths from the display surface to a mirror facet and onwards via a reflection.

In FIG. 8 and other figures, display surfaces are illustrated as if translucent. In case a display surface is a display screen such as an LCD display, the display surface is typically not translucent. In case the display surface is a piece of cloth for back-projection, the display surface will be translucent. The general use of translucent illustrations of display surfaces is adopted so that important aspects are not hidden.

In a preferred embodiment, the one or more display surfaces are located in a plane that is parallel to the pyramoid base plane and intersects the point that corresponds to the pyramoid apex of the fundamental pyramoid from which the display pyramoid is derived. In a display pyramoid with same sides that all form an angle with respect to the pyramoid base plane of 45 degrees, the displayed object will appear to be at the very center of the display pyramoid.

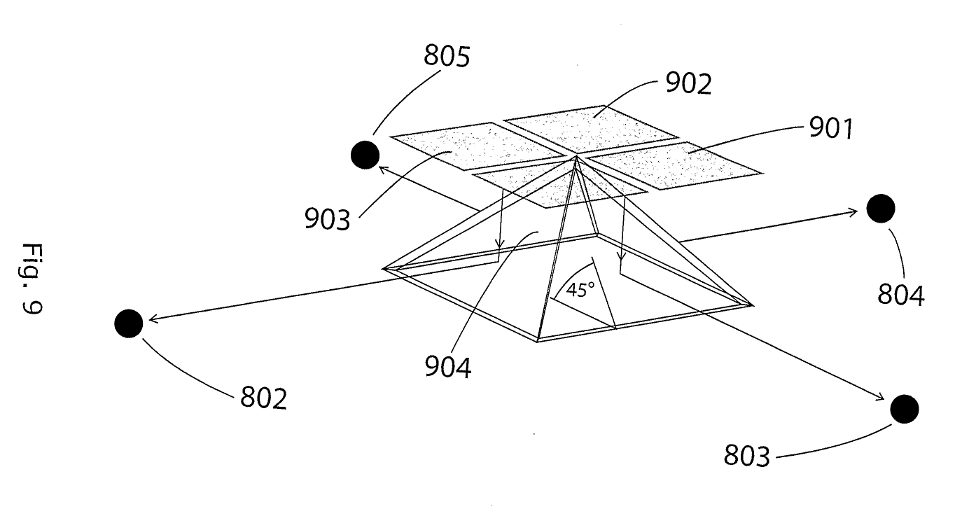

FIG. 9 illustrates a display device according to the invention, comprising a display pyramoid similar to that in FIG. 5A and display means comprising four individual display surfaces 901-904. A large composite display surface can be formed for instance by combining several smaller LCD displays. Using several smaller displays is in some ways quite practical. However, images cannot be displayed at the interfaces between the display surfaces, which in many cases is undesirable or at least somewhat inconvenient. However, in many cases it is not a critical problem.

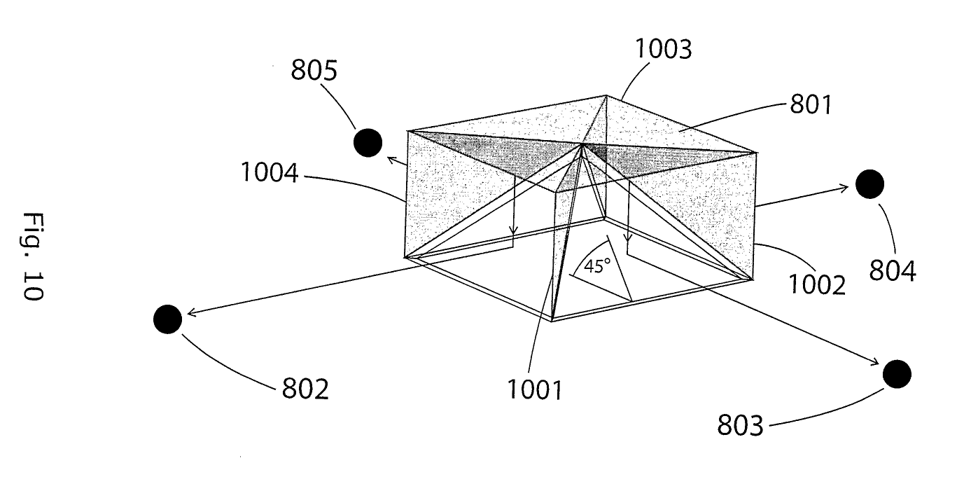

FIG. 10 illustrates a display device similar to that in FIG. 8, further comprising light shades 1001-1004. Light shades can prevent unwanted reflections from combining in the eyes of a viewer. Addition of light shades is therefore often a desirable modification.

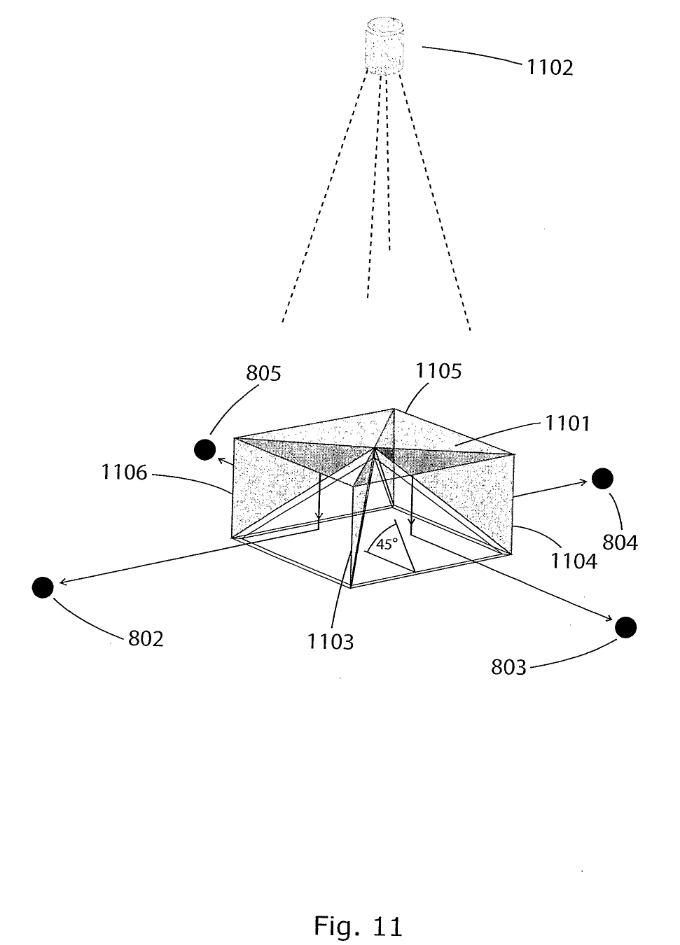

FIG. 11 illustrates an embodiment of the invention wherein the display means is an image-forming surface 1101. The embodiment further comprises light shades 1103-1106. The image-forming surface is backlit by a projector 1102. If the display pyramoid is large, if for instance the pyramoid base is 3 m×3 m, a display surface such as an LCD display is hardly practical. The setup in FIG. 11 may be a more practical solution.

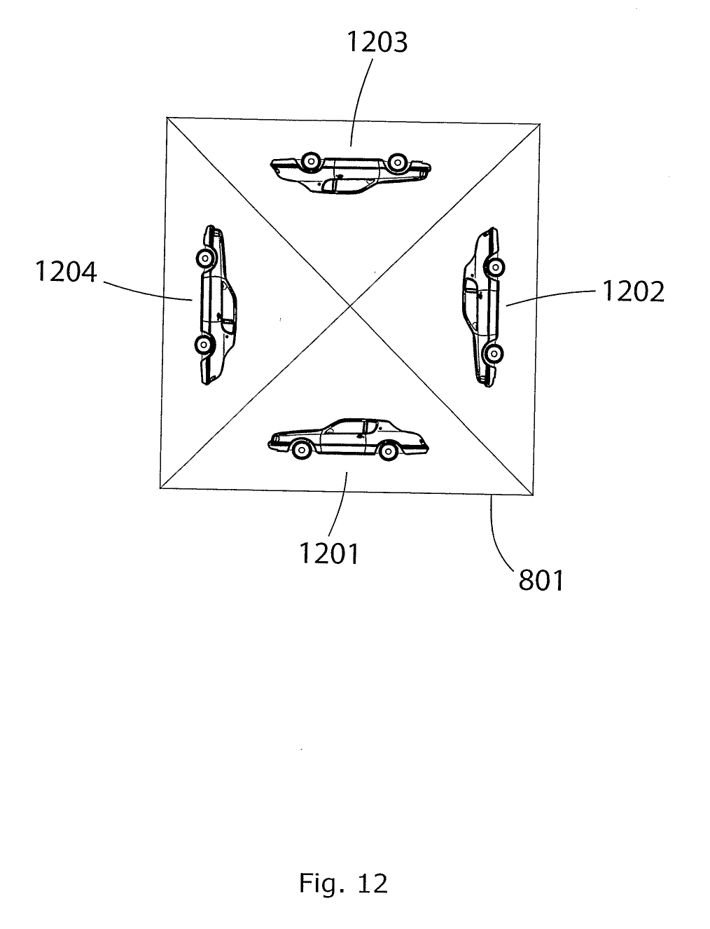

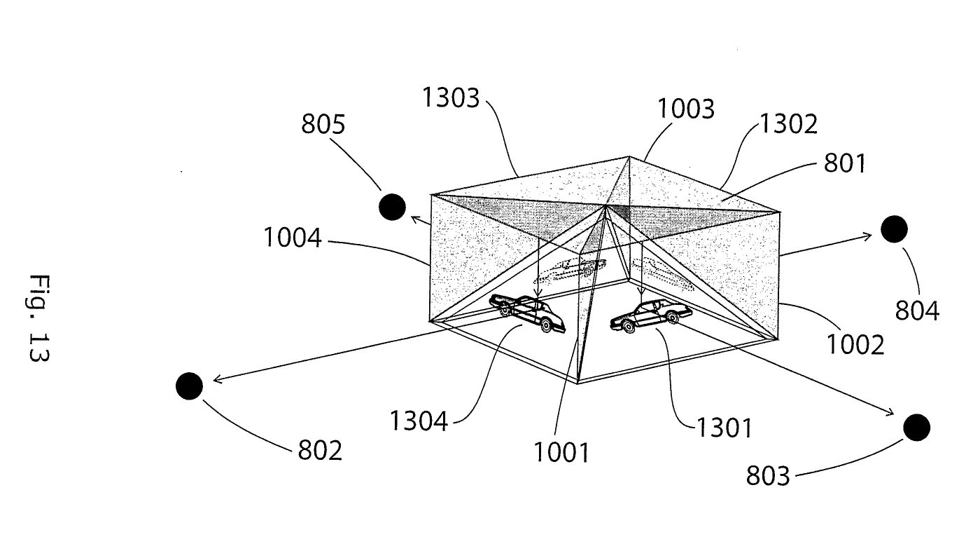

FIG. 12 illustrates a layout of four same images 1201-1204 on a display surface 801 as for instance in the display device in FIG. 10. FIG. 13 illustrates a display device as in FIG. 10, wherein the images on the display surface are composed as in FIG. 12. Four viewers viewing the display device from points 802-805 will see the same image or images and can communicate to each other their experiences of the displayed images. This is a useful setup for viewing images and communicating at the same time, face to face. This is in contrast to four persons watching a same screen and then turning to face each other before communicating. Another feature of this particular image layout is that the displayed images from two adjacent display screen sections may combine in a rather smooth fashion when viewed from a direction along a diagonal of the pyramoid base plane. This effect requires that same pictures be shown on adjacent mirror facets. When a person is viewing the display device while moving about, this will be an advantage because it provides a better display of the object.

A viewer looking for instance at the image 1301 from point 803 will perceive the displayed object as being placed inside the display pyramoid. The focus point lies at the display surface part that lies above the mirror facet for image 1301, not at the mirror facet itself. The semi-transparency of the display facets allows the viewer to look inside the pyramoid. A viewer observing a display facet will see the inside of the display pyramoid and at the same time see the reflection of the image displayed in the section of the display screen that lies above that facet. Because the image on the display screen is combined with the view of the inside of the display pyramoid, a viewer will have a strong tendency to perceive the displayed object as being a physical object placed inside the display pyramoid. The display device thus takes the two-dimensional look provided by a two-dimensional display and transforms it into what may be called a quasi-three-dimensional (“quasi-3D”) picture. It is an important feature in any setting wherein the “look and feel” of an object is an important aspect, for instance in a demonstration, presentation or promotion setting.

This will significantly add to the sense that the object is a physical object placed inside the display pyramoid. If the images on the display surface are isolated by their outline, the quasi-3D perception will be further enhanced. An image can be isolated using a cutout technology. Images are recorded against a single-colored background. In postproduction, the background can be removed, for instance by computer processing, and be replaced by black. On an LCD display, the background will be black and only the object can be seen.

A further spatial aspect can be added by rotating the object dynamically. A viewer's brain will create a 3D image of an object from 2D image information provided by displaying the object in rotation. This feature is carried over into the present invention. In any scenario, the images on the display surface can be still or moving pictures.

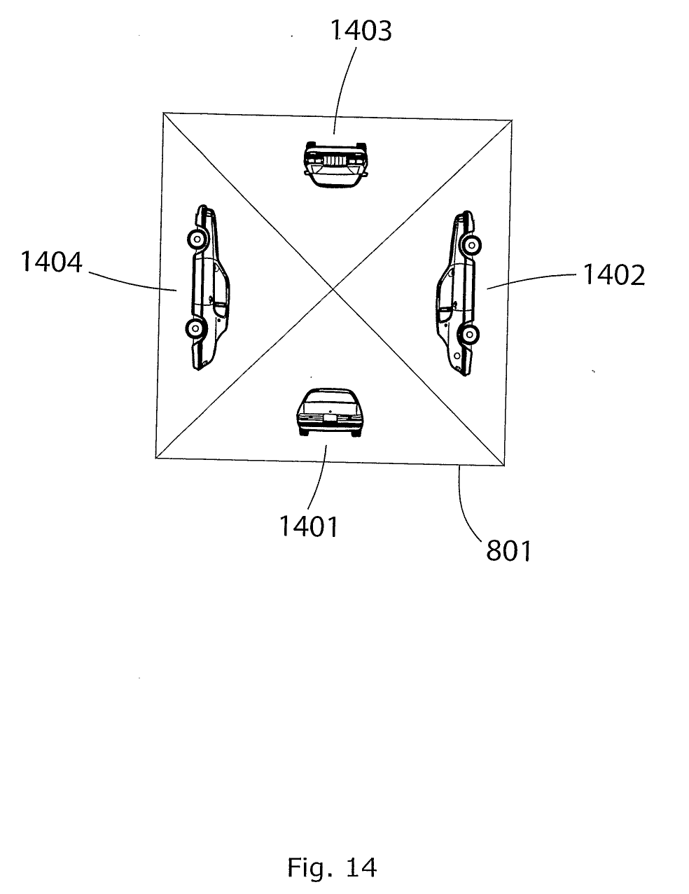

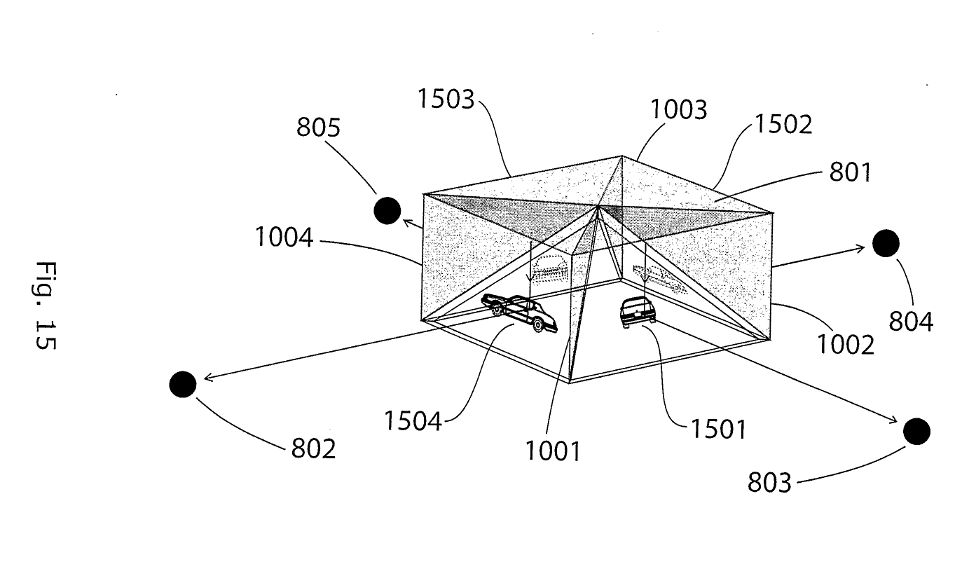

Because the invention offers the extra spatial aspects described above, it can be very useful as a display unit in a design process. It allows a user to gain a more intimate relationship with the object on display. In a design process, this is often a very important aspect. The sense that the object is material creates a design environment for the user that stimulates the creative process. Presently, an object designed on a 2D surface, such a computer display or on paper, is often realized physically in a so-called mock-up to allow the designer to truly experience the object of the design. Producing a mock-up is typically a relatively costly process because each version of the design is a prototype and thus needs a prototypical fabrication process. The present invention can aid a user in gaining a better understanding of the object the way it would appear in a mock-up version, but without the user having to actually produce such a mock-up. FIG. 14 illustrates a layout of images 1401-1404 on a display surface 801 as for instance that in the display device in FIG. 10. The images 1401-1404 are recordings of an object from four different angles separated by 90 degrees. FIG. 15 illustrates a display device as in FIG. 10, wherein the images on the display surface are composed as in FIG. 14. A viewer walking around the display device will experience a spatial aspect of the object added by this particular layout, on top of the quasi-3D experience inherently provided by the invention. This provides a possible substitute for making a mock-up during the design process as described above. Also, when more than one person, say four persons, observe the display device, and each person observes a separate mirror facet, the persons will be able to communicate among them their unique experiences. In a design scenario, this may provide a useful instrument for communicating about organic properties of the object. Essentially, this replicates a situation where the observers are looking at a mock-up of the object from separate angles. As before, use of cutout technology will further enhance the already strong sense of three-dimensionality. Mirror facets 1501-1504 reflect images 1401-1404, respectively.

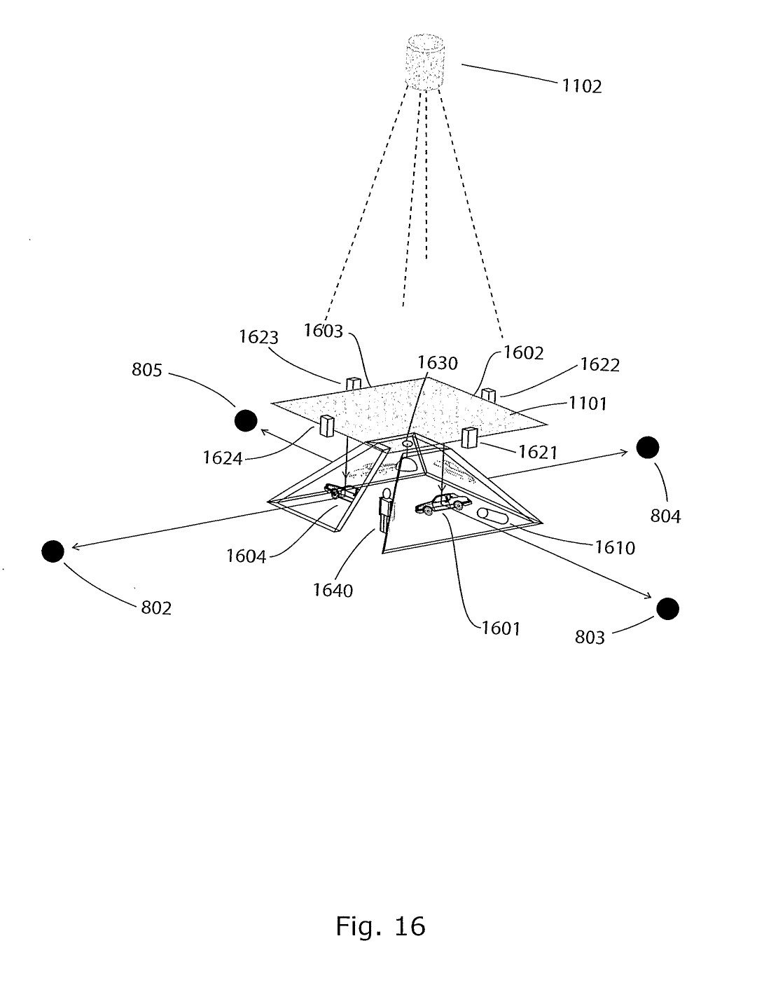

FIG. 16 illustrates a large display device comprising an image-forming display surface 1101 as that in FIG. 11; mirror facets 1601-1604, all of which comprise hole; microphone means 1610; speaker means 1621-1624; lighting means 1630; and a person 1640. A projector is provided to illuminate the image-forming display surface to provide the images to be reflected on the mirror facets 1601-1604. The person 1640 inside the display pyramoid is visible through the semi-transparent mirror facets. The hole provides extra visibility. The lighting means 1630 may be used to illuminate the person. The microphone means can be used to record whatever the person is saying. A viewer at any of points 803-805 will be able to observe both the person and images reflected on the mirror facets. A viewer near point 802 must move slightly to the left to be able to see both the person 1640 and the reflection in 1604. In a demonstration, presentation or promotion setting, this combination of the view of the person and the reflected images can be used in a very powerful way. The person can “interact”—in the eyes of a viewer—with the images displayed on the display surface. For instance, the person could show and tell about a car, as illustrated in FIG. 16. The person's words can be reproduced by the speaker means 1621-1624. Sound from other sources may also be provided through the speaker means. This could be music played back via playback equipment connected to the speaker means.

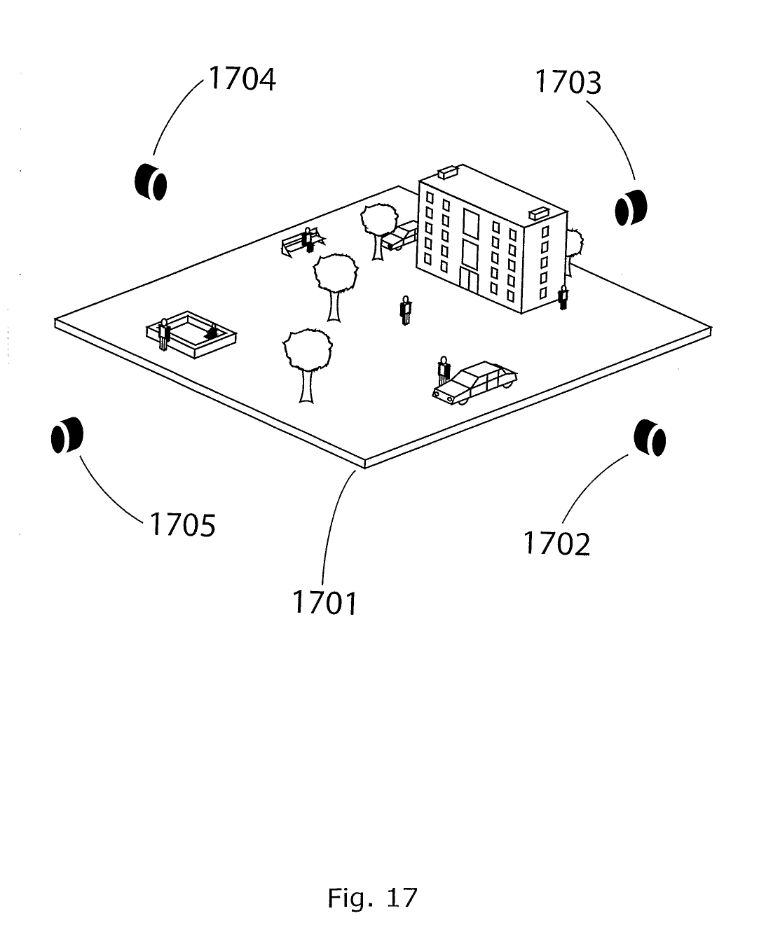

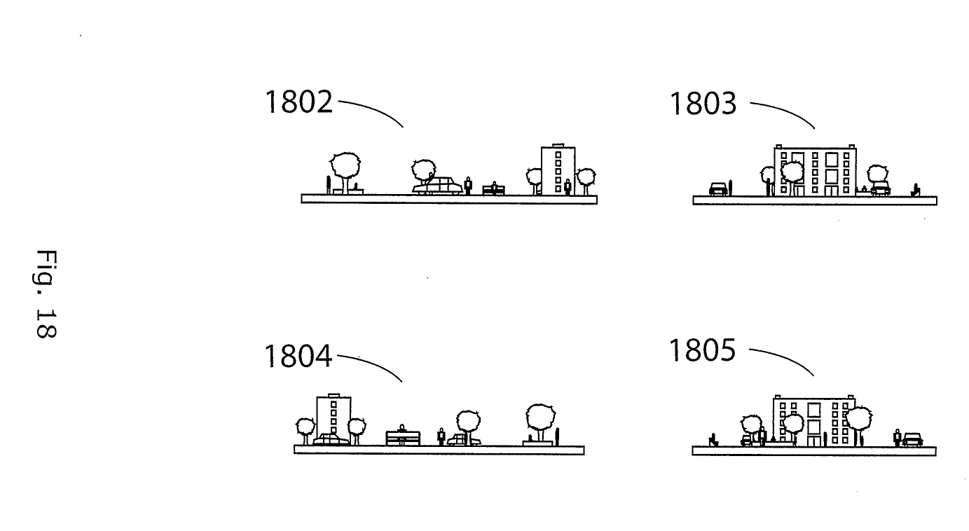

FIG. 17 illustrates a location 1701 and four image and/or sound recorders 1702-1705. The location in FIG. 17 contains housing, parking, a playground and a recreation area. It may be desired to keep this location under remote observation for instance to prevent criminal activity in the area. Each camera of 1702-1705 records images from the location from a separate angle. The image recordings are illustrated in FIG. 18. The image 1802 is recorded by camera 1702; image 1803 is recorded by camera 1703, and so on. The recorders 1702-1705 may also simultaneously make sound angle recordings.

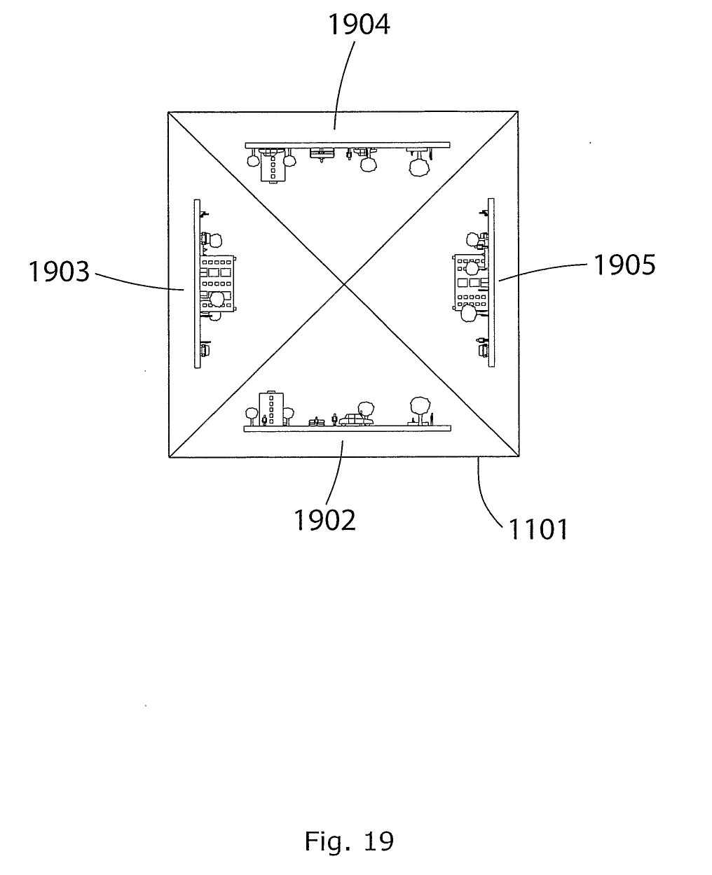

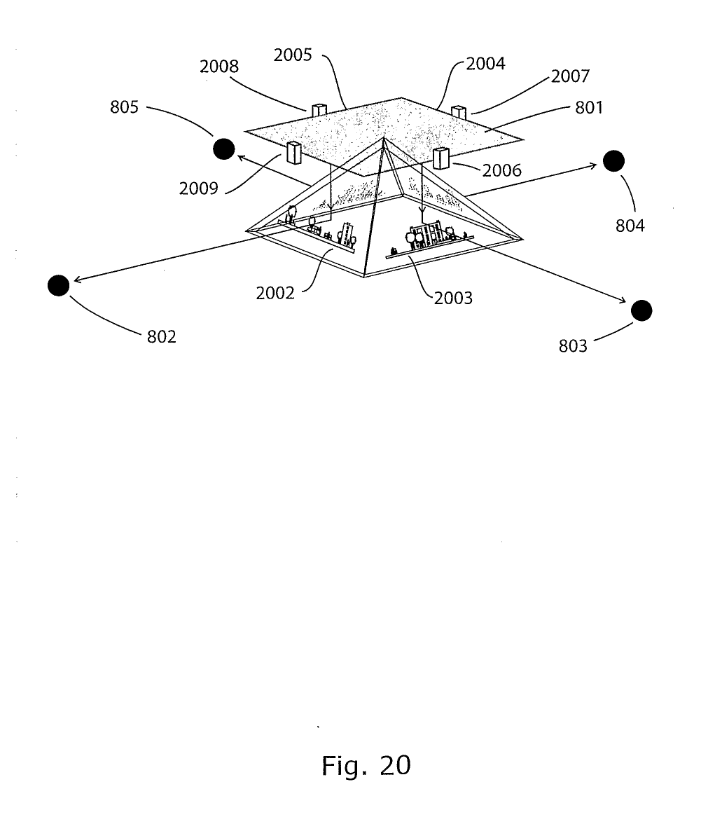

FIG. 19 illustrates a layout of the image angle recordings 1802-1805 in FIG. 18 on a display surface 801 as in FIG. 10. Section 1902 displays 1802 in FIG. 18, 1903 displays 1803, and so on. FIG. 20 illustrates a display device similar to that in FIG. 10, wherein the images on the display surface are composed as in FIG. 19. Image 1802 in FIG. 18 is reflected in mirror facet 2002, Image 1803 in FIG. 18 is reflected in mirror facet 2003, and so on. By moving around the display device, for instance between points 802-805, a person can survey the location 1701 in an intuitive way. This is in contrast to a setup where the image angle recordings are displayed on four screens that are lined up on a wall. The spatial aspect is an important aspect when one is trying to judge and perceive the dynamics at the location. Sound angle recording made by the recording units 1702-1705 can be reproduced by speaker means 2006-2009 to add a further aspect of reality the remote surveillance of the location 1701.

Because the mirror facets are semi-transparent, objects inside the display pyramoid will be visible from the outside. To the observer, the displayed images will appear together with the events that take place inside the pyramid. In a straightforward and inexpensive way, this feature could be used to visualize how a location, such as 1701, would appear if an object were introduced somewhere at the location. In a surveillance scenario, this can be used for to study how the introduction of an object, such as a tree, can affect the visibility as seen from the cameras 1702-1705.

The location could also be a sports arena, such as a soccer field. The display device can provide a viewer with a very real sense of being present at for instance a soccer match that takes place at the location, because a person can move around and watch the match from different angles in an intuitive way. Sound reproduced by the speaker means 2006-2009 should represent the image recording angles so that a viewer at a given point—such as one of 802-805—will experience the correct combination of images and sound.

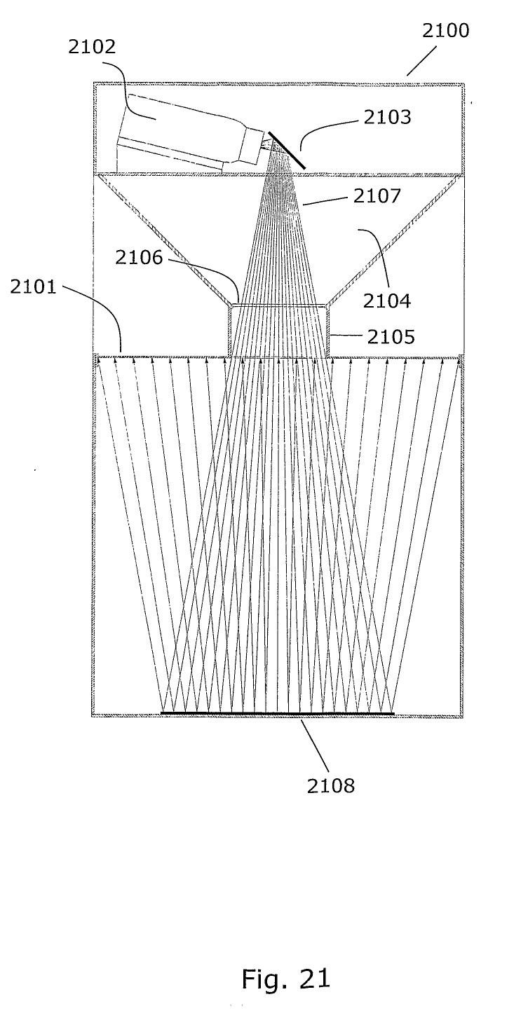

FIG. 21 illustrates a specific, practical design of a presentation stand 2100 based on a display device similar to that in FIG. 11. In FIG. 21, the projector from FIG. 11 is “folded” back into the stand 2100 to save space, which results in a very compact presentation stand. Light, illustrated by rays 2107, from the projector 2102 is reflected in mirror 2103 and travels through the “top” 2106 (a hole) of the display pyramoid part of the presentation stand 2100. Item 2104 illustrates a mirror facet of the display pyramoid. The display pyramoid is sitting on a stand 2105. The light 2107 is reflected in mirror 2108 and the images to be reflected at mirror facets 2104 of the display pyramoid are formed at image-forming surface 2101, made for instance of cloth.

In a surveillance scenario that includes more than one location, a configuration including a corresponding number of display devices can greatly aid the observer in processing the events both at the individual locations, as described above, but also in processing the spatial relationship between the different locations. The display units would be positioned with respect to each other in a fashion that is spatially true to the physical layout of the locations. An observer can watch the scene at each location by moving around the corresponding display pyramid. If an object or being moves from a first location to a second location, the observer can follow the object or being in a fashion that is spatially true to the actual scenario, by moving from the pyramid showing the first location to the pyramid that shows the second location. This may allow the observer to better comprehend the overall dynamics that takes place in the area under surveillance.

The display device is also useful as a display unit in computer gaming. Four game players can sit around the display device and observe their individual angle of the action. The intimacy provided by the setup can provide an extraordinary degree of intensity and involvement, even if the players are not observing a common point of view. Speaker means could be either integrated, or they could be external speakers, such as loud speakers or headsets.

In building-sized embodiments, the invention can also be used for residential or commercial purposes. In such embodiments, it may be useful to place the display device upside-down, so to speak, having the pyramoid base point upwards and the display surface or surfaces placed below to emit light upwards towards the mirror facets of the display pyramoid.

1. A display device comprising
an at least partly semi-transparent display pyramoid derived from a fundamental pyramoid, said display pyramoid comprising a pyramoid base plane and at least three semi-transparent display pyramoid mirror facets (said number is denoted n),
display means comprising one or more image display surfaces positioned outside the display pyramoid, each image display surface being positioned in such a way that light to be emitted from said one or more image display surfaces can reach directly at least a part of one or more of the display pyramoid mirror facets.

2. A display device according to claim 1, wherein each display pyramoid facet has a coverage ratio of at least 0.25.

3. A display device according to claim 1, wherein a longest distance from any point on any display surface to any point on the display pyramoid is equal to or less than twice a longest edge of the fundamental pyramoid.

4. A display device according to claim 1, wherein light shades are placed on the pyramoid edges, one light shade at each edge, said light shades being placed and shaped in such a way that the one or more display surfaces are divided into n image sections, each of which can transmit light to only one pyramoid facet.

5. A display device according to claim 1, wherein the one or more display surfaces are substantially plane.

6. A display device according to claim 5, wherein the one or more display surfaces lie in a common plane.

7. A display device according to claim 6, wherein the common plane is substantially parallel to the pyramoid base plane.

8. A display device according to claim 1, wherein there is exactly one display surface.

9. A display device according to claim 1, wherein all display pyramoid mirror facets have the same size.

10. A display device according to claim 1, wherein the display pyramoid has one or more cavities.

11. A display device according to claim 1, further comprising lighting means.

12. A display device according to claim 1, further comprising speaker means.

13. A display device according to claim 1, further comprising microphone means.

14. A display device according to claim 1, further comprising an image processor connected to the display means for generating images to be displayed on at least one of the one or more display surfaces.

15. A method for reproducing still or moving pictures from a location, comprising the steps of
making picture angle recordings of the location from one or more angles, and
displaying at least one of the picture angle recordings using a display device according to claim 1.

16. A method for reproducing sound and still or moving pictures from a location, the method comprising the steps of
making picture angle recordings and sound angle recordings at the location from one or more angles, and
displaying at least one of the picture angle recordings on the one or more display surfaces of a display device according to claim 1 and reproducing sound via speaker means, either via the display device if said display device comprises speaker means, or by speaker means provided not as part of the display device.

17. A method according to claim 16, wherein the device further comprises microphone means and sound is recorded via said microphone means and reproduced via the speaker means.

18. A method according to claim 15, wherein the one or more picture angle recordings are shown in separate display regions of the totality of the one or more display surfaces, and wherein the device contains light shades positioned and shaped in such a way light to be emitted from a display region can reach directly one and only one display pyramoid mirror facet.
